(19) United States
(12) Patent Application Publication
(10) Pub. No.: US 2002/0023018 A1
(43) Pub. Date: Feb. 21, 2002

(54) Method and system for network-based community for sharing information services

(76) Inventor: Robert Kleinbaum, Saline, MI (US)

Correspondence Address: OSTROLENK FABER GERB & SOFFEN, 1180 AVENUE OF THE AMERICAS, NEW YORK, NY, 100368403

(21) Appl. No.: 09/885,245

(22) Filed: Jun. 19, 2001

Related U.S. Application Data
(60) Provisional application No. 60/212,887, filed on Jun. 20, 2000.

(51) Int. Cl. G06F 17/60

(52) U.S. Cl. 705/26

(57) ABSTRACT

A method and system using a communication network, such as the Internet, the forum community for sharing information services. Users of the method and system allows members to share people, information resources, companies and professional service firms. The community comprises five main forums, a community building, knowledge bank, public forum, purchase services and shopping mall. Members share expertise and business experiences, as well as cooperating on requests for proposals. The community is always evolving in response to user input to meet the needs of the community.

### CROSS-REFERENCE TO RELATED APPLICATIONS

The present application claims priority to U.S. Provisional Patent Application Ser. No. 60/212,887 filed Jun. 20, 2000 and entitled “METHOD AND SYSTEM FOR NETWORK BASED COMMUNITY FOR CONSULTING SERVICES”.

### FIELD OF THE INVENTION

The present invention relates to a system and method for creating a networkbased community for sharing information and services. In particular, the present invention relates to a method and system for creating a network-based community that allows users to share resources, including professional knowledge and services, and further to enable users to share their expertise on managing those resources.

### BACKGROUND OF THE INVENTION

Many businesses are faced with tasks and assignments which are difficult or 15 impossible to meet. Businesses cite to changes in industry and technology, shortages of skilled personnel, and new business practices among the reasons why many tasks and assignments cannot be completed. In order to compete successfully, businesses from many different industries hire third-party consultants to assist in completion of projects.

While businesses can profit from the services provided by consulting companies, the associated costs are very high, estimated to be in the several tens of billions of dollars annually. Some businesses lose money on ventures with consulting companies because associated costs are higher than revenues. Further, there is a great concentration of the overall consulting market in a very few number of consulting companies. Given the high demand for consulting services with the concentration of the market in a very few number of consulting companies, businesses are vulnerable to cost increases and potential consulting service-related problems as a result.

Therefore, there is a need for a cost effective method for businesses to obtain the professional services they require and, further, to obtain them as securely, safely and inexpensively as possible.

### SUMMARY OF THE INVENTION

The present invention provides a system and method designed to bring professional service users together with others in a networked community environment that helps to strengthen each of the member participants. By using this system, members are able to help each other to obtain professional services that they require. The present invention further provides a networked computer system linked to a communication network, such as the Internet, from which potential users access a virtual community to learn about and retain the professional services they require.

Still another feature of the present invention is a method by which members share professional service expenses with other members to solve a common problem or set of problems. Further, a method by which members are encouraged to discuss issues of concern with other members in order to add to the joint knowledge base of the community is provided. A method by which individuals from member organizations interact with others from different member organizations is also provided in order to share common experiences, discuss problems and to obtain professional services.

The present invention also provides a method by which members communicate with each other electronically and wherein requests for online symposiums to address areas of interest are submitted. A method for members to access information databases is also provided and maintained. Additionally, a method by which members, as well as members of the public, suggest future content and ways to enhance user satisfaction is available.

The present invention further provides a method for member professional service providers to market their services to members in a cooperative community environment as well as to individual members. A central, networked community which links prospective users to various sections of the community is also provided.

At least one public database of knowledge where all users, regardless of status, access limited information and interact with other users is also provided. Additionally, cost reductions are available by managing shared professional service providers more effectively, in order to strengthen alliances and relationships among peers. Knowledge bases are also built within the membership itself rather than themselves within the professional service community.

### BRIEF DESCRIPTION OF THE DRAWINGS

The features and advantages of the present invention will become apparent from the following description of the invention which refers to the accompanying drawings, in which:

FIG. 1 is an example of a hardware arrangement for a network-based community information and services sharing system constructed in accordance with the principles of the present invention;

FIG. 2 is a block diagram of the functional elements of information processors, databases and user terminals provided;

FIG. 3 is a block diagram of the overall organization of a networked community of members;

FIG. 4 is a diagram illustrating a Community Building Forum;

FIG. 5 is a block diagram of a Knowledge Bank Forum;

FIG. 6 is a diagram disclosing a Public Forum;

FIG. 7 illustrates a Purchase Services Forum and a Shopping Mall forum;

FIG. 8 outlines new user registration according to one embodiment of the present invention;

FIG. 9 diagrams an information (About Us) section; and

FIG. 10 shows a help system according to an embodiment of the present invention.

### DETAILED DESCRIPTION OF THE EMBODIMENTS OF THE INVENTION

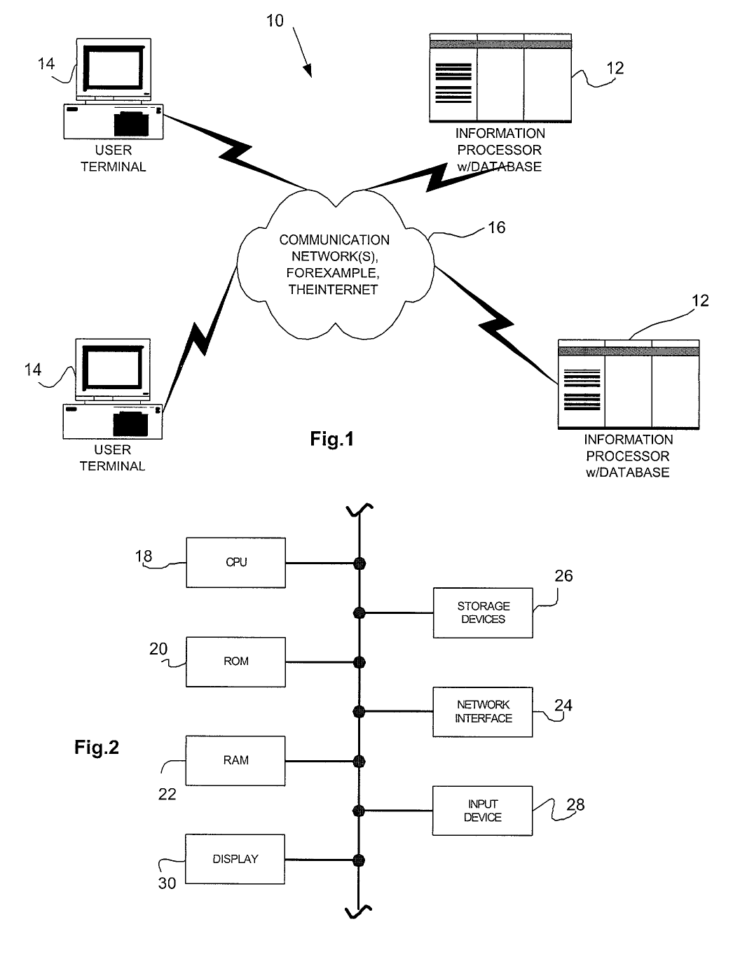

Referring to the drawing figures in which like reference designators refer to like elements, there is shown in FIG. 1 an example of a hardware arrangement for a network based community for sharing content information and services constructed in accordance with the principles of the present invention and designated generally as “10. ” System 10 is comprised of at least one information processor 12 and at least one user terminal 14, each of which are coupled to communication network 16. Communication network 16 is preferably a global public communication network, such as the Internet, but can also be a private value added network (“VAN”) or the like.

Information processor 12 and user terminal 14 can be any devices that are capable of sending and receiving data across communication network 16, e.g., mainframe computers, mini computers, personal computers, laptop computers, personal digital assistants (PDA) or Internet access devices such as Web TV. In addition, user terminals 14 are preferably equipped with a web browser, such as MICROSOFT INTERNET EXPLORER, NETSCAPE COMMUNICATOR and the like. Information processors 12 and terminals 14 are coupled to communication network 16 using any known data communication networking technology.

As shown in FIGS. 1 and 2, the functional elements of each information processor 12 include one or more central processing units (CPU) 18 used to execute software code and control the operation of information processor 12, read-only memory (ROM) 20, random access memory (RAM) 22, one or more network interfaces 24 to transmit and receive data to and from other computing devices across a communication network, storage devices 26 such as a hard disk drive, floppy disk drive, tape drive, CD ROM or DVD or storing program code, databases and application data, one or more input devices 28 such as a keyboard, mouse, track ball, microphone and the like, and a display 30.

The various components of information processor 12 need not be physically contained within the same chassis or even located in a single location. For example, storage device 26 may be located at a site which is remote from the remaining elements of information processors 12, and may even be connected to CPU 18 across communication network 16 via network interface 24.

Information processors 12 include a database equipped with sufficient storage to provide the necessary databases, forums, and other community services described herein, as well as acting as a web server for communicating hypertext markup language (HTML), XML, Java applets, Active-X control programs and the like, to user terminals 14. Information processors 12 are arranged with components, for example those shown in FIG. 2, suitable for the expected operating environment of information processor 12. The central processing unit(s) 18, network interface(s) 24 and memory and storage devices are selected to ensure that capacities are arranged to accommodate expected demand.

The functional elements shown in FIG. 2 (designated by reference numerals 18-30) for processors 12 are the same categories of functional elements also present in user terminals 14. However, not all elements need be present in all user terminals 14 in the same size and configuration. For example, CPU 18 in user terminal 14 is typically a smaller capacity CPU than the CPU present in the information processor 12. Similarly, it is likely that the information processor 12 will include storage devices of a much higher capacity than storage devices present in user terminal 14.

Of course, one of ordinary skill in the art will understand that the capabilities of the functional elements can be adjusted as needed. The nature of the invention is such that one skilled in the art of writing computer executable code (software) can implement the described functions using one or more or a combination of a popular computer programming languages including, but not limited to C++, Visual Basic, Java, Active-X, HTML and web application development environments.

Although the present invention is described by way of example herein and in terms of a web-based system using web browsers and a web site server (information processor 12), system 10 is not limited to the above configuration.

It is contemplated that system 10 can be arranged such that user terminals 14 can communicate with and display data received from information processors 12 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on user terminal 14, for example, WINDOWS 3.x, WINDOWS 95, WINDOWS 98, WINDOWS NT, WINDOWS 2000, WINDOWS MILLENNIUM, WINDOWS CE, Mac OS, UNIX, LINEX, Palm OS and any suitable PDA or palm computer operating system.

As used herein, references to displaying data on user terminal 14 refers to the process of communicating data to the terminal across communication network 16 and processing the data such that the data is viewed on the terminal displays 30 using a web browser or the like. As is common with web browsing software, the display screen on terminals 14 present sites within the networked community and system 10 such that a user can proceed with from site to site within the system by selecting a desired link.

The above-described hardware provides a system which advantageously allows users to determine easily and quickly if the professional service providers under consideration had done well in similar engagements. Users, depending on their status, are able to visit at least a Public Forum, a Help System and an About Us section. In one embodiment, the community includes the following additional forums: Community Building, Purchase Services Forum, Knowledge Bank and Shopping Mall.

Many of the examples provided herein concern Fortune 500 companies and the knowledge and services they currently buy from professional service firms, i.e., consulting firms. Many companies are starting their own internal consulting companies in order to lower consulting costs, retain learning and to develop their own people. The consulting services examples provided herein are for explanatory purposes and are not intended to limit the invention to any such instrunentalities. The present invention has broad applicability in other service industries, including computer programming industries, law practices, medical practices, etc.

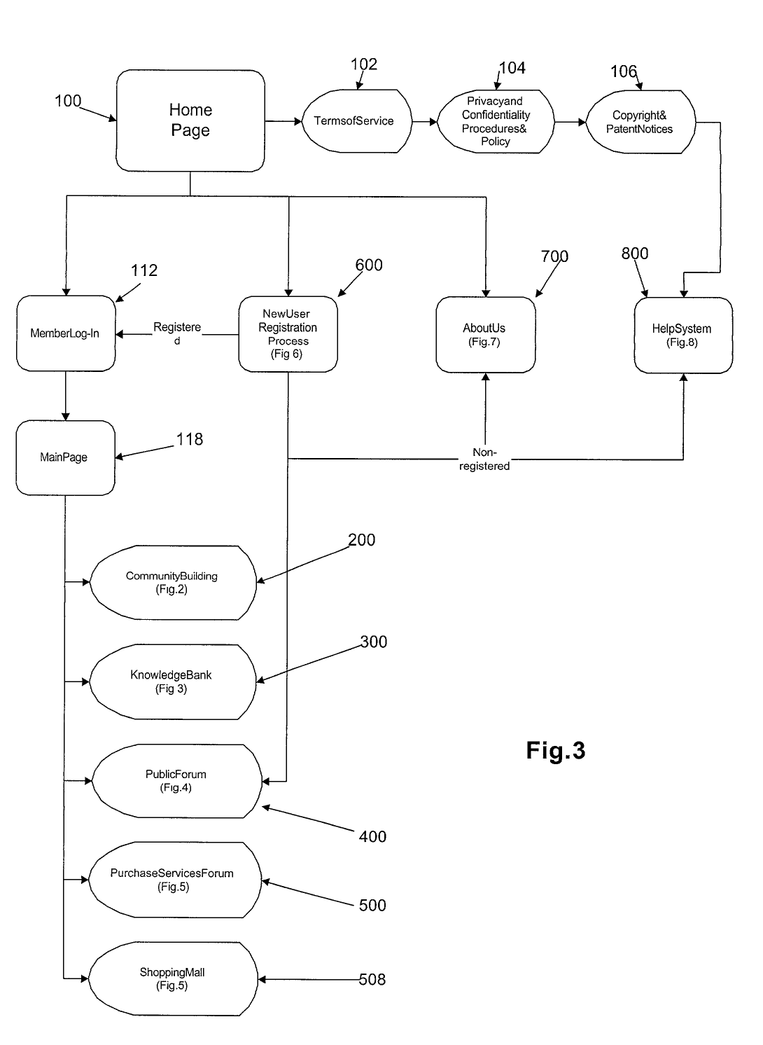

FIG. 3 is a block diagram and presents an overall view of a system and method for operating a network-based community according to the principles of the present invention. A Home Page 100 is utilized to link the entire community together in a convenient, searchable and logical manner to facilitate user interaction. Various procedural and other notices are linked to this page such as terms of service 102, privacy and confidentiality procedures and policies 104 and copyright and patent notices 106.

A registered user is preferably prompted to access Member Log-in 112 directly from Home Page 100 and, after logging into the system, he or she is preferably provided with Main Page 118. In accordance with the principles of the present invention, and in order to provide adequate security as is known in the art, a new user is directed to Member Log-in 112 after he or she has registered with the system using New User Registration Process 600. Preferably, the system is arranged such that a user is not able to access the Main Page 118 if the user is not registered and has not logged into the system.

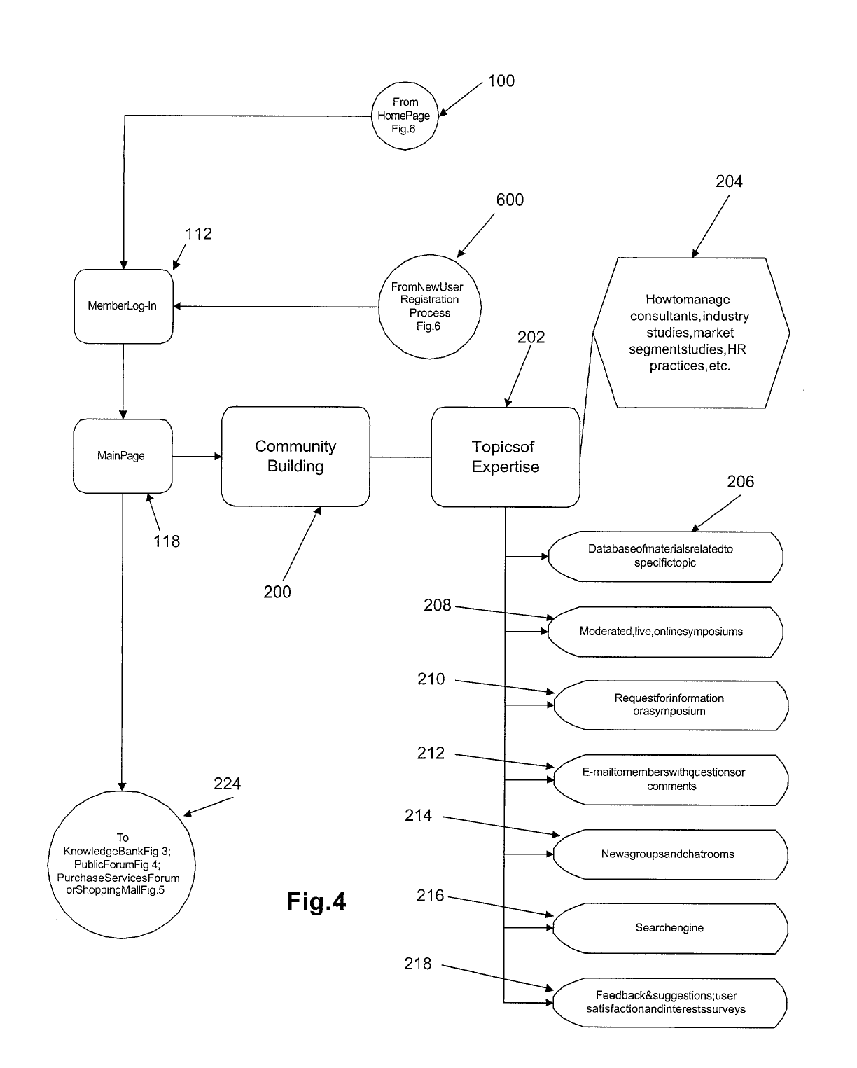

Once a user terminal is presented with Main Page 118, users are able to enter Community Building 200 or continue on to other links such as Knowledge Bank 300, Public Forum 400, Purchase Services Forum 500 or Shopping Mall 508 (see FIGS. 3 and 4). It is easy for members to start conversations, exchange knowledge on topics of their choice and otherwise collaborate as they see fit. Active discussion rooms dedicated to specific topics, databases on the topics and moderated on-line symposiums and search engines are included in system's 10 functionality. It is preferred that each member be able to set up his or her own discussions and define appropriate access to the discussions.

Security and access to system's 10 web site content are controlled by complementary means. For example, members define user profiles which determine any given user's read and write access to various types of web site content. Some members may have only read access to web site content, while others, e.g., members who post reports to the Knowledge Bank 300, may have read and write access for the reports they submit.

Further, when a member adds content to the web site, he or she defines the desired level of access for the posted material. The posting user can restrict access to specific users, e.g., registered users, registered company users, members of a specified group of companies, members of a specified list of companies, or specific individuals. Other embodiments of user-controlled access to posted materials can be developed based on feedback from customers and other sources, in accordance with the principles of the present invention.

Technical security measures are employed to assure confidentiality and security of any content information posted to the community. Data communications between information processor 12 and user terminal 14 may be encrypted using an appropriate encryption protocol (for example using the 32-bit encryption capabilities of current browser software). In another embodiment, IP addresses for users are recorded at the time of registration and only communications from the IP address registered to a specific user is accepted. In still a further embodiment, digital signature technology may be employed to authenticate users. Other embodiments may be developed as security technology advances to assure that the best-available security measures are employed.

The community provider preferably charges member organizations a fee to join the community. The fee is preferably charged on a yearly basis. In one embodiment, fees are charged on a sliding scale depending on the size of the organization, the amount of business transacted, and the number of individuals associated with the organization who are expected to utilize the system 10. Additional revenue is generated by charging “rent” to participating professional service providers for “space” in the Shopping Mall 508. Further, paid advertisements to be viewed by users are also included in the revenue generating portion of the present invention.

Although the community provider wants to maximize the profit making potential of the present invention, it is very important that nothing damages the trust that users place in the community provider. The community provider strives to maintain a fair, unbiased position in order to successfully operate the networked-based community for sharing information and services.

It is preferred that all web pages are linked to a Help System 800 that can be accessed by all users. Help System 800 provides information to new and returning users to assist in the use of System 10.

Individuals accessing the Home Page 100 will either go through New User Registration Process 600 (first-time users) or Member Log-in 112 (returning members). Users choosing not to register are preferably given access to limited portions of the web site such as About Us 700 and Help System 800. Other configurations regarding on-line help and restricted access are envisioned without departing from the spirit of the present invention. Users who have successfully logged into system 10 by using Member Log-in page 112 are preferably directed to Main Page 118. Registered users who are logged in will have access to user forums including Community Building 200, Knowledge Bank 300, Public Forum 400, Purchase Services Forum 500 and Shopping Mall 508. These forums are described in detail below.

In a preferred embodiment, the community provider includes one or more personnel representatives who provide assistance for members. A personnel representative will help members to find solutions to their respective tasks by providing application and technical support. The community provider personnel representative will also assist members by assisting in locating resources. For example, the personnel representative will submit queries to other members or participating service providers to assist members with solutions to other respective questions.

COMMUNITY BUILDING

In accordance with the principles of the present invention, users can retrieve specific information and communicate with each other by using a conveniently designed interface. In a preferred embodiment, a “Community Building” 200, substantially as shown in FIG. 4, is designed to mimic a physical building with rooms that provide members with a familiar, easy and simple way to communicate with other members on a variety subjects. Retrieving subject matter from inside Community Building 200 is preferably done by using a search engine 216. Search engine 216 can preferably be used to retrieve information by, for example, keyword, topic, consulting firm, business unit, individual person or other otherwise searchable criteria.

Further, the method of communication inside the Community Building 200 for members is flexible. Members can preferably interact with each other using “chat” technology, electronic bulletin boards, e-mail, and other methods of network-based communication, e.g., voice and video conferencing in the Community Building 200. Further, rooms in the Community Building 200 can preferably be added by users to address topics of interest. A room can be added easily by a user, for example by clicking on a designated portion of the screen, for example, a Windows “button.” Users may add rooms for a variety of reasons, including moderating live on-line symposiums 208, requesting information or symposiums 210, e-mailing members with questions or comments 212, accessing news groups and chat rooms 214. A room allowing feedback and suggestions, user satisfaction and interest surveys 218 may also be included. By mimicking a physical building, the Community Building 200 seems familiar to users, is easy to navigate and encourages users to interact.

Further, it is preferred to maintain a database of materials related to specific topics 206. Topics in the database in the Community Building 200 are preferably dedicated for specific issues including industry studies, market segment studies, marketing strategy, financial strategy, human resources, best practices, strategic planning, managing consultants and the like.

In a preferred embodiment, members have the ability to control access to rooms in the Community Building 200. It is preferred that groups provide defining attributes regarding themselves and, if desired, establish private, secure areas for communication. For example, non-compete groups or key alliances may be allowed access to specific rooms, while others are restricted. It is further preferred that members have the ability to define sub-communities to restrict users who are not associated with the given sub-communities from accessing specific places and activities. Security and confidentiality are preferably user-controlled within these user defined sub-communities. Alternatively, users can choose to communicate anonymously. Members will also, preferably, be able to customize on-line, desktop environments and customize the way information and data are exchanged. Currently, software known as “groupware” is available for customizing data and communication interchanges, and groupware software may be employed by the present invention for these reasons.

The Community Building 200 is advantageous in that members are provided with information beyond commercial marketing materials. A member can confer with other members regarding specific topics, for example a comparison of consulting firms. A firm's respective performances, strengths and weaknesses can be shared in order to assist members during a consultant selection and management process. In addition to benefitting members, small consulting companies with limited marketing resources can significantly benefit from the present invention because members can refer other members to these smaller companies. Additionally, large consulting firms can benefit from the present invention because high marketing costs can be reduced and direct feedback regarding performance can be easily obtained. Of course, the present invention, and in particular the Community Building 200 can provide benefits in many industries in addition to the consulting industry, such as medical and legal practices.

KNOWLEDGE BANK

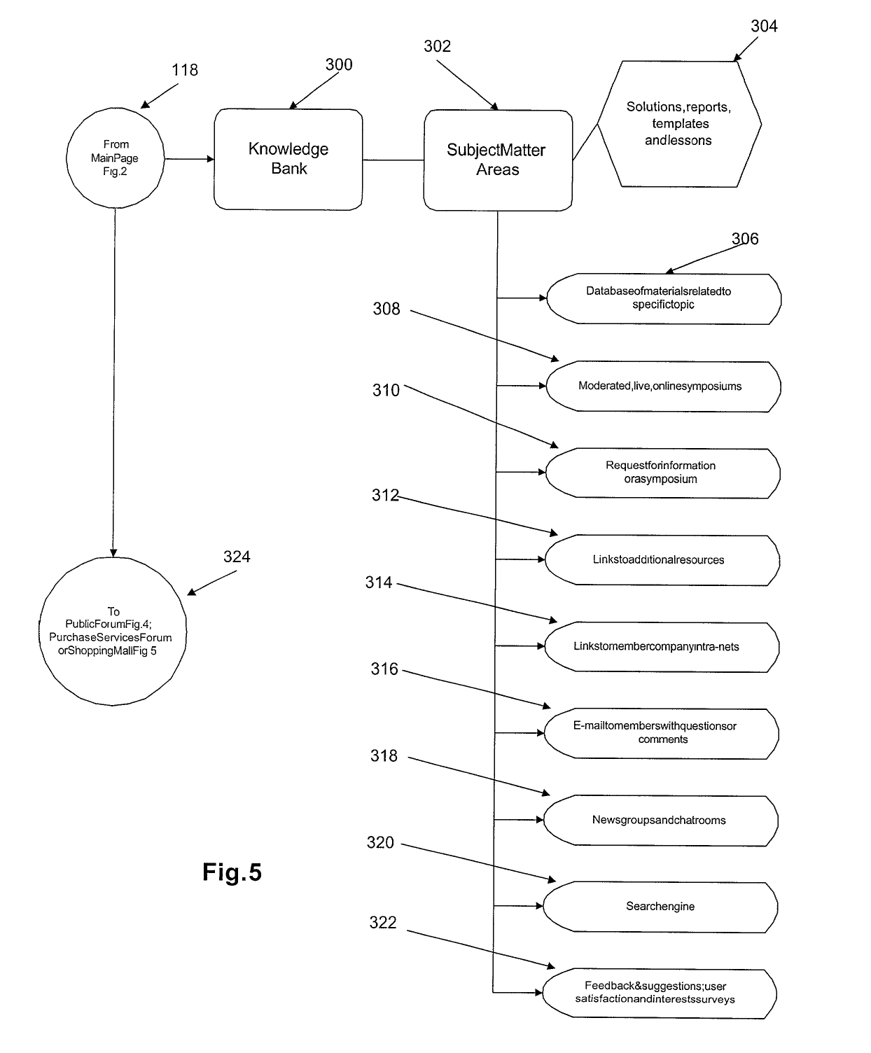

In addition to the Community Building 200, a member may access a dedicated area for a variety of knowledge and content information. Substantially as shown in FIG. 5, this area is referred to herein as the “Knowledge Bank” 300. Once members are logged in the system, they can preferably enter the Knowledge Bank 300 from Main Page 118 to retrieve content information. The content information is preferably stored in easily retrievable and searchable data sources, for example, databases (e.g., Oracle™based, SQL Serverm™, MS-Access™), word processors (e.g., Adobe Pagemaker™, WordPerfect™, MS-Word™), spreadsheets (Excel™, Lotus 123™, Quattro™) and presentation programs (Powerpoint™, Ventura™).

Registered members are preferably able to access areas of the Knowledge Bank 300 by clicking on associated links. Additionally, it is preferred that a variety of forums, each specialized in a particular area, for example human resources, information technology resources, business research and the like are included in the Knowledge Bank 300. Further, a database of materials relating to specific topics 306 is preferably available in the Knowledge Bank 300 and is further expanded upon by members as new topics are submitted. As in the Community Building 200, moderated, live and on-line symposiums 308 can be offered on either a scheduled or an ad hoc basis. Furthermore, requests for information can be made in symposium 310, in e-mail forum 312, and in news groups and chat rooms 314. Other features including a search engine 318 and a feedback and suggestions forum 322 are available from the Knowledge Bank 300. Preferably, links to additional resources 308 and links to member companies' corporate intranets 310 are also available in the Knowledge Bank 300.

PUBLIC FORUM

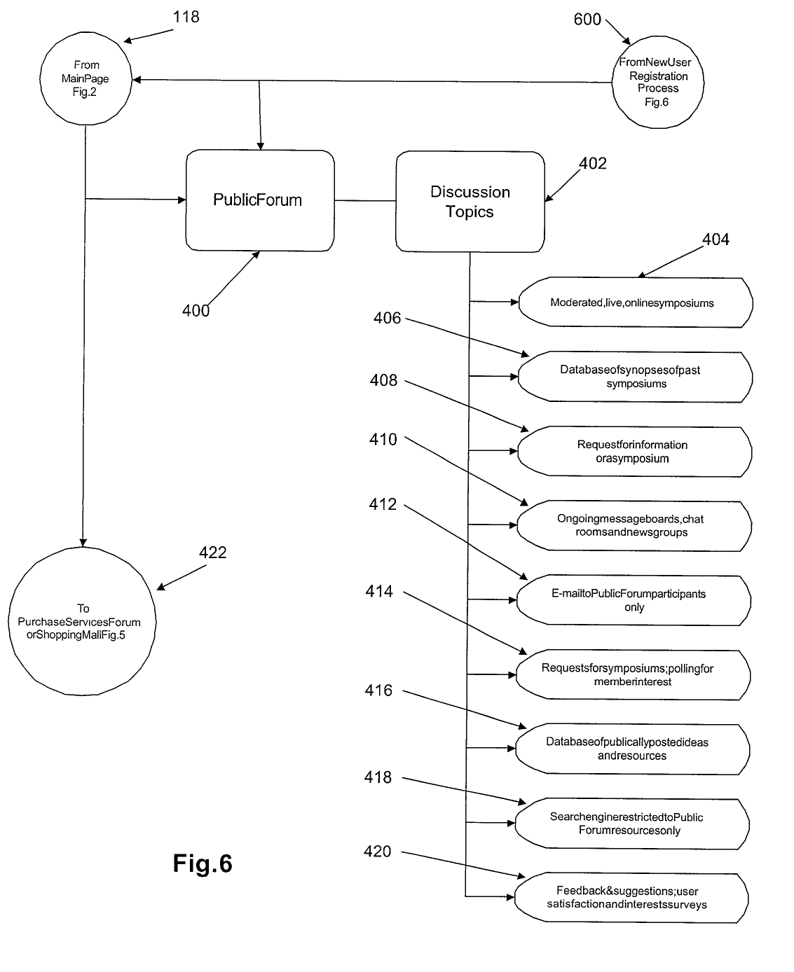

The Public Forum 400, substantially as shown in FIG. 6, is a place for members to meet with non-members, e.g., consultants, academics and other nonmembers. Public Forum 400 preferably invites a broad sharing of ideas to discuss topics of interest and for participants to offer ideas freely. For example, consulting companies, think tanks, and universities can participate in the Public Forum 400 to assist in meeting a members' needs.

Registered members are preferably able to access areas of the Public Forum 400 by clicking on associated links. Additionally, it is preferred that a variety of rooms, each focused on a particular area, for example, human resources, information technology resources, business research and the like are included in the Public Forum 400. Further, a database of materials related to specific forum-related topics 404 is preferably available in the Public Forum 400 and can be expanded upon by members as new topics become available. As in the Community Building 200, moderated, live, on-line symposiums 408 can be offered on either a scheduled or an ad hoc basis.

Further, requests for information in a symposium 410, an e-mail forum 412, news groups and chat rooms 414, search engine 416 and a feedback and suggestions forum 422 are preferably available in the Public Forum 400.

PURCHASE SERVICES

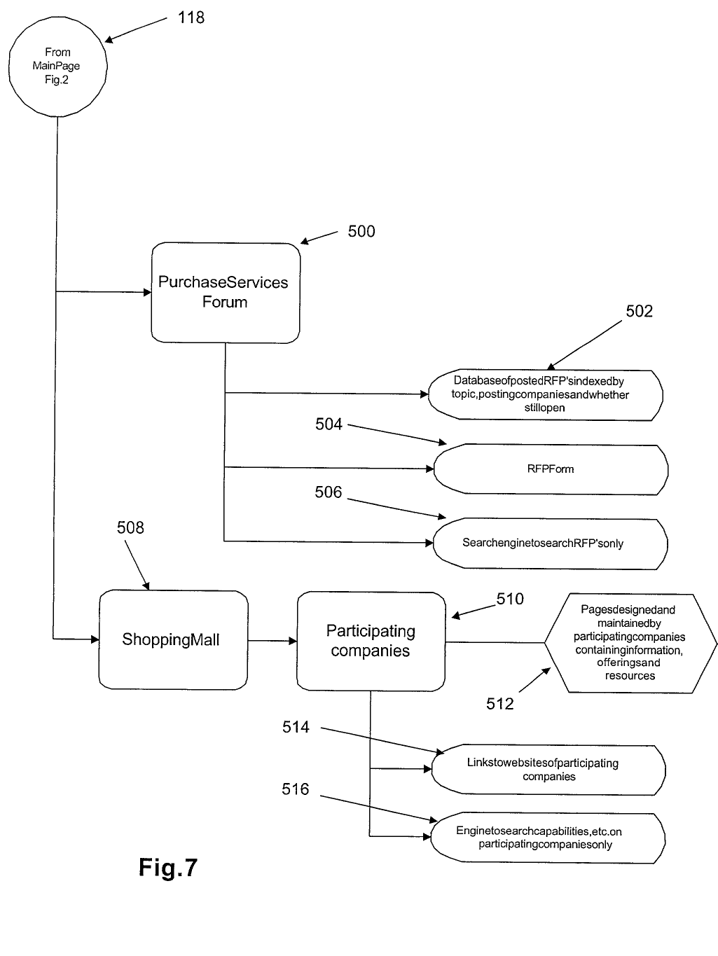

In addition to members being able to retrieve information, engage in communication and evaluation, and to query databases for answers to specific questions, the present invention provides a forum for members to purchase services. Users preferably enter the purchase services forum 500 from Main Page 118. FIG. 7 shows an example of a Purchase Services Forum 500 that gives members an opportunity to request proposals directly from providers listed with the community. For example, proposals submitted by members to consulting companies preferably refer to projects in which members have a need to complete. Projects may be structured so that common portions of a quote are customized to allow members to share costs. By allowing members to cooperate when purchasing, consulting companies may be prevented from reselling identical services to a plurality of members.

As noted above with regard to the Community Building 200, small-sized companies, e.g., small consulting firms, benefit by gaining exposure to members who may require the small firm's services. Exposure to a market segment typically incurs a great deal of financial costs. By offering a Purchase Services Forum 500, the present invention can advantageously alleviate some of these costs. Small consulting firms can invest associated savings in other business ventures. Moreover, small companies can enter into a bidding process with larger companies and may successfully acquire projects by charging less.

Further, members can preferably use the present invention to share costs for services in order to purchase a block of services, e.g., by giving a promise to a provider for future services at a reduced cost. For example, a consulting company can benefit by a commitment from a group of members' purchase of $1,000,000 worth of consulting services over five years at a discounted rate. The guarantee of future services reduces uncertainty in the future for the service provider, and reduces costs for the consumer. Members will also benefit by acquiring knowledge that accompanies inter-company collaboration. Companies will benefit by establishing business relationships which can lead to future commitments and engagements.

The community provider also can preferably charge firms a percentage of contractual fees earned for providing services to members. This “community fee” can be structured so that when a company increases its profit share, the fee charged by the community provider proportionally increases. The community provider will preferably reinvest a percentage of the fees charged to companies in the system 10. The community provider may further credit a percentage of the community fee towards the purchasing member's participation fees in the following year.

FIG. 7 also shows Shopping Mall 508. Shopping Mall 508 provides an opportunity for companies to set up “virtual stores” or display areas for the purpose of selling or providing information regarding their services or products. Participating companies are preferably charged a fee for “space” in the Shopping Mall 508. Companies that participate in Shopping Mall 508 can include links to their respective company websites 514.

USER MAINTENANCE

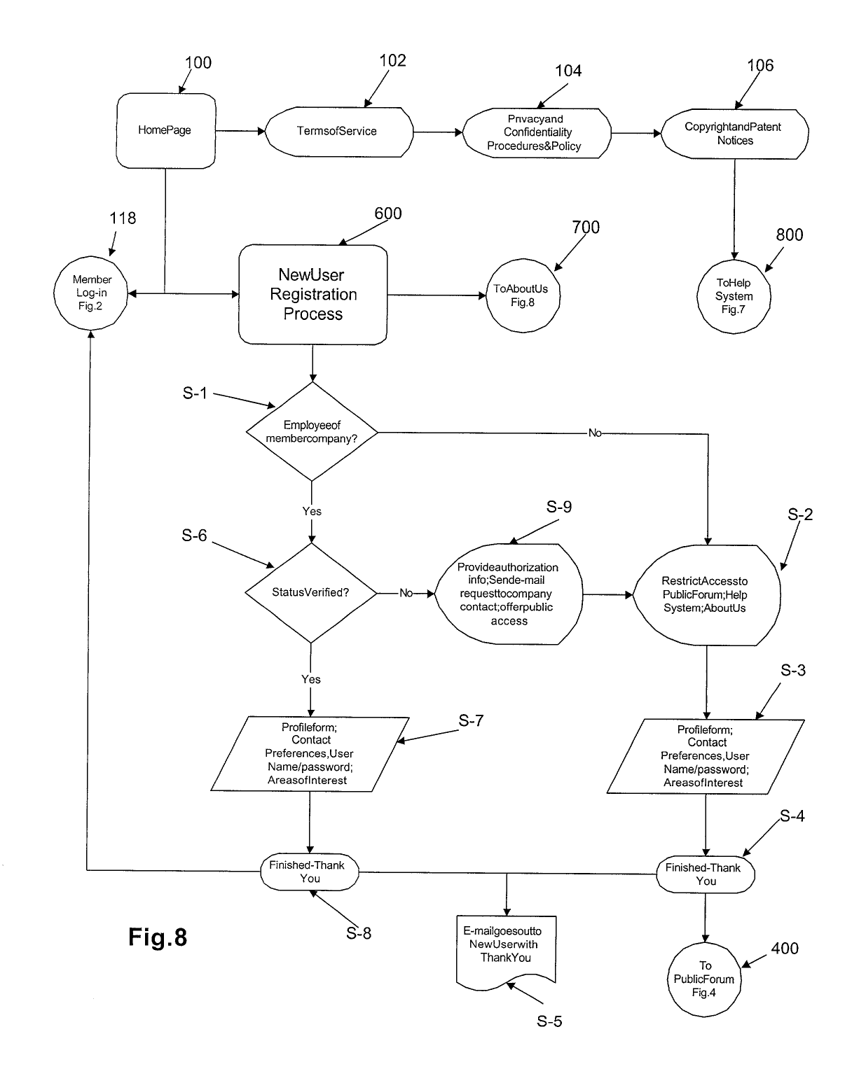

FIG. 8 is a combined, block diagram-flow chart showing an embodiment of New User Registration 600. Users clicking on Home Page 100 preferably view terms of service 102, privacy and confidentiality procedures and policies 104 and copyright and patent notices 106. A non-registered user using the New User Registration Process 600 may also link (without registering) to About Us 700. A new user, choosing to register, is preferably asked if the user is an employee of a member company S-1. If the answer to that question is NO, access is restricted to the Public Forum 400, Help System 800 and About Us 700 sections. A newly registered user is preferably asked to fill out a profile form including contact preferences, user name/password and areas of interest S-3 and then the registration process ends S-4. The newly registered user has access to the Public Forum 400 and an e-mail may be sent to the new user welcoming them.

If the user is an employee of the member company, they are directed to a verification step S-6. If the status cannot be verified, the user provides authorization information; the system sends e-mail requests to the company contact, and public access is offered to the user S-7. This user (like the non-employee user above) is restricted to the Public Forum 400, Help System 800 and About Us 700 sections and continues through steps S-2, S-3, S-4 and S-5 as previously discussed. Once the new user's status has been verified (at a later point in time), the user is granted full privileges with respect to system 10.

A user who is an employee of a member company and whose status has been verified preferably fills out a profile form, contact preferences, user name and password and areas of interest S-7. This user is fully registered and has access to all sections of the networked community through the Member Log-in page 118. Additionally, an e-mail is also sent to the new user S-5 thanking him or her for joining the community.

In one embodiment, the e-mail S-5 is sensitive to whether the intended recipient is a verified registered user or not and is tailored depending on registration status.

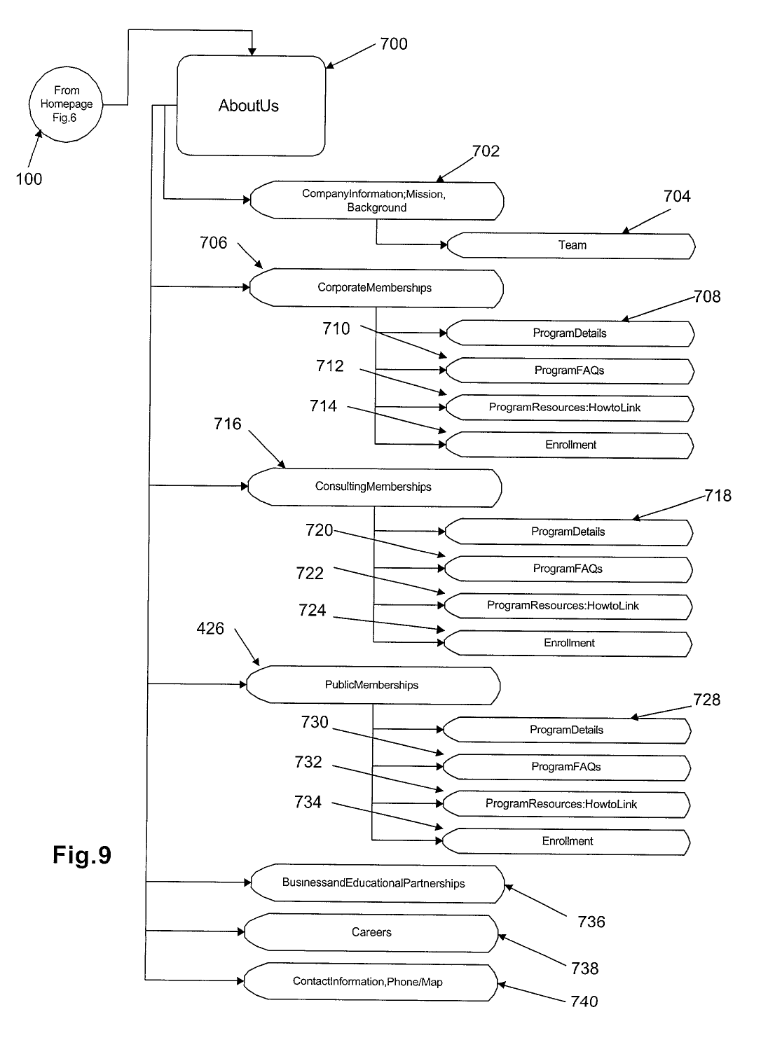

In one embodiment, a section containing general information about the community is included in system 10. For example, a section called About Us 700 is shown in FIG. 9. About Us 700 is preferably linked from Home Page 100. Examples of the kind of information that is made available in this section 700 is company information and mission background 702 along with teams and team members 704. Information regarding corporate memberships 706 includes program details 708, program frequently asked questions (FAQ's) 710, program resources for how to link up with the other offerings or enrollment information 714. Additionally, information regarding consulting membership 716 includes any program details 718, program FAQ's 720, program resources how to link 722 and enrollment information 724.

Information about public memberships 726 preferably includes at least program details 728, program FAQ's 730, program resources how to link 732 and enrollment information 734. Information regarding business and educational partnerships 736, career development and careers 738 and contact information, phone directory and map of the site 740 are also included.

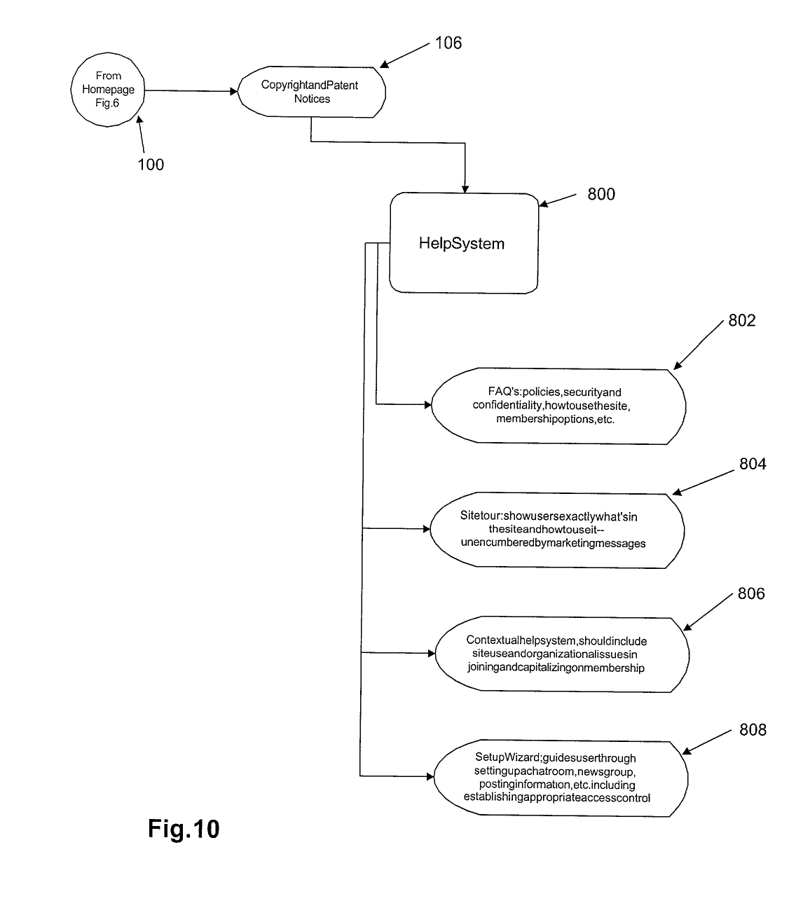

It is preferred to have a context sensitive Help System as shown in FIG. 10. The Help System 800 can either be directly linked through Home Page 100, through a series of notices 106 as shown in FIG. 8 or from links present on all pages. Although many embodiments are possible, it is preferable to at least include information regarding FAQ's, policies, security and confidentiality, how to use the site, membership options, etc. 802. This information provides visitors to the site an overall idea of the usefulness of the site to them. Site tour 804 also aids in allowing users to decide whether they want to register or simply visit the public areas.

Preferably, the context-sensitive Help System 806 includes information about site use, organizational issues in joining and capitalizing on membership 806. A Setup Wizard 808 guides users through the process of setting up a chat room, news group and posting information, etc. including establishing the appropriate access control to the rooms.

### EXAMPLES

An example of one member utilizing the features of the present invention described herein is now provided with respect to FIGS. 8-10.

A member wants to lower warranty costs in her business. The member enters the Community Room 200 and queries whether anyone has been faced with a similar task. The personnel representative who is available for the member provides suggestions regarding other appropriate forums to query and further provides techniques for querying members and researching archives. The member's queries lead to discussions with other members who have completed similar, albeit not identical, projects.

The member invests additional time reading through discussion threads in the Knowledge Bank 300. The discussion threads from the Knowledge Bank 300 provide new links to specific members and to corporate intranets. The member receives new information and proceeds to analyze the information. Follow-up discussions with other members occur and within two days, the member is prepared to enter the Purchase Services Forum 500 to begin negotiations with consultants. The member submits a request for services to the consulting community regarding reduction of warranty costs and receives five responses within one week. The member returns to the Community Building 200 and queries members regarding their experiences with the responding consulting companies. After narrowing the number of consulting company choices down to three, the member engages in in-person meetings with the consulting companies.

Thereafter, the member chooses one company to assist in the project. The member uses the information from the System 10 to negotiate a fair agreement. The member creates a secure room in the Community Building 200 and engages in realtime, on-line discussions with the chosen consulting company. The member's representative continues to monitor the member's progress and offers suggestions regarding the use of symposiums 208. As new issues arise during the project's execution, the member continues to employ the various on-line resources available in the System 10. For example, academics are queried in the Knowledge Bank 300 who provide further guidance during the project.

Upon completion of the project, the member submits information regarding her experiences in the System 10 for the benefit of other participating members. For example, the type of project and key contacts are submitted in the Community Building 200. The consulting company and other service providers, (e.g., academics) use during the project are formally reviewed by the member and the reviews are also submitted in the Community Building 200. The member also begins an on-line discussion thread to provide some general lessons from the project. Additionally, the secure room previously created in the Community Building 200 is saved for future access, and additional divisions within the member's organization will use the secure room to assist them in the procedures incorporated within the System 10.

An example of one consulting company utilizing the features of the present invention described herein is now provided.

A consulting company (“company”) wants to develop new marketing channels. The company enters information regarding the consulting services it provides in a forum dedicated for consultants in the Purchase Services Forum 500. For example, the company enters areas of specialty, work experience, fee rates and demographics data. Additionally, the company adds a link to its web site to direct users of the System 10 to the company's web site. In order to assist in the company's efforts to succeed by using the System 10, a representative of the community provider locates experts in the Community Building 200 and facilitates discussions on business-related topics.

In time, a member looking for consulting services contacts the company. The member is seeking assistance with reducing warranty costs. The member submits specifications regarding project and after a negotiation process, the company and member enter into an agreement. The terms of the agreement require the company to make some adjustments to the way the company typically does business. For example, the company will regularly access a secure room in the Community Building 200 to engage in real-time, on-line discussions with the contracting member. During the course of completion of the project, the company benefits from these changes in its business practice. The project is completed on schedule and within the proposed budget. Helpful member feedback is provided to the company. The company uses the feedback to improve the nature of the consulting company's business. Future business relationships are thereafter secured.

The present invention scales easily since costs are basically fixed and revenue increases proportionally with membership. Another advantage is that System 10 is not static and grows as members and companies conduct business. As System 10 grows, additional management may be required of the community provider to ensure continued success. Value added functions such as managing information and data can also be provided. Costs to members may eventually decline as the amount of business transacted in System 10 increases.

Further, technology is not a major barrier or expense in this business. Present “off the shelf” software is used to operate the forums, knowledge exchange and information storage and is inexpensive and readily available. Since the present invention is not a trade exchange, there is no need to develop new software to integrate purchaser and vendor systems. Users of the present invention can get started very quickly and do not have to rely on untried, expensive or difficult technology.

The present invention utilizes “positive reinforcing networking” which drives the system. The value of this method depends on how many join since it is predicated upon the exchange between its members. Competition from traditional consulting companies is unlikely since traditional consulting companies would need to divest themselves from the purchasing decisions of the members of the instant community. This is unlikely to happen and is generally be viewed as undesirable by traditional consulting companies.

In addition to the consulting industry, users benefit from the present invention when applied to a broad range of service-related industries. For example, the present invention can be applied to attorney services, medical services, accounting services, human resource services, general financial services and clerical services. Moreover, professionals offering building and renovation services, automotive repair services, travel related services, and a host of others can offer use the present invention to market themselves.

Although the present invention has been described in relation to particular embodiments thereof, many other variations and modifications and other uses will become apparent to those skilled in the art.

We Claim

1. A method for sharing information and services regarding providers of at least one of goods and services, the method comprising:
maintaining an electronic site connected to a communication network to which the at least two users connect;
providing at least one electronic knowledge forum on the electronic site, wherein the at least two users share information regarding at least one of a common need and experience;
providing at least one database on the electronic site wherein the at least two users store and retrieve data; and
providing at least one electronic shopping forum on the electronic site wherein at least one user requests at least one of services and goods from at least one provider of at least one of services and goods:

2. The method of claim 1, further comprising providing an electronic services forum, wherein at least one of the at least two users makes a request for at least one proposal from the at least one provider.

3. The method of claim 2, further comprising allowing the at least two users to share in the request for the at least one proposal in the electronic services forum.

4. The method of claim 1, further comprising registering at least one of the at least two users by requiring the at least one user to provide user information in a user-profile regarding the at least one user.

5. The method of claim 4, wherein at least one of the at least two users who registers by providing user information in the user-profile is considered a registered user; and
wherein at least one of the at least two users who does not register by not providing user information in the user profile is considered a non-registered user.

6. The method of claim 5, further comprising providing the at least one registered user with access to a plurality of user-forums for registered users and a plurality of user-forums for non-registered users.

7. The method of claim 6, wherein more user-forums for registered users are provided than are user-forums for non-registered users.

8. The method of claim 5, further comprising providing at least one non-registered user with access to a plurality of user-forums for non-registered users, and wherein the at least one non-registered user is not entitled to access a plurality of user-forums for registered users.

9. The method of claim 5, further comprising entering content information provided by at least one registered user into a database.

10. The method of claim 9, farther comprising a first registered user limiting access of a second registered user to the content information based on the second registered user's user-profile.

11. The method of claim 9, further comprising a registered user defining a group of registered users that are entitled to access the content information submitted by the registered user.

12. The method of claim 11, wherein the registered user defining the group is an employee of a first company, and the group of registered users comprises employees of a second company.

13. The method of claim 11, wherein the registered user defining the group and the group of registered users are employees of a first company.

14. The method of claim 5, providing at least one non-registered user with access to the at least one database containing content information.

15. The method of claim 5, wherein at least two registered users share costs associated with at least one of services and goods provided by at least one provider of at least one of services and goods; and
wherein the at least two registered users share benefits resulting from the at least one of services and goods received from the at least one provider of at least one of services and goods.

16. The method of claim 5, wherein at least one electronic forum is added by at least one registered user.

17. The method of claim 5, wherein at least one registered user requests a symposium using the electronic site.

18. The method of claim 5, wherein at least one registered user communicates using electronic newsgroups and chatrooms provided on the electronic site.

19. The method of claim 1, further comprising retrieving content information using a search engine to access a database in accordance with at least one search criterion.

20. The method of claim 1, further comprising at least one of the at least two users completing at least one survey of the at least one user's experiences with the electronic site.

21. The method of claim 1, wherein the at least one provider maintains an independent electronic communication site, the method further comprising furnishing, on the electronic site, access to the independent electronic communication site.

22. The method of claim 1, further comprising charging a fee to the at least one provider.

23. The method of claim 22, further comprising calculating the fee as a function of an amount of business transacted on the electronic site.

24. The method of claim 22, further comprising calculating the fee as a function of a number of users purchasing at least one of services and goods from the at least one provider.

25. The method of claim 1, further comprising charging a fee to a user for participation in the electronic site.

26. The method of claim 25, further comprising calculating the fee as a function of an amount of business transacted by the user.

27. The method of claim 1, further comprising charging a fee to a group of users for participation in the electronic site.

28. The method of claim 27, further comprising calculating the fee as a function of a number of users in the group.

29. The method of claim 1, wherein at least one provider solicits business on the electronic site with advertisements.

30. The method of claim 1, further comprising providing a chat facility on the electronic site.

31. A system for sharing information and services regarding providers of at least one of goods and services, the system comprising:
an electronic site connected to a communication network to which at least two users connect;
at least one electronic knowledge forum on the electronic site, wherein the at least two users share information regarding at least one of a common need and experience;
at least one database on the electronic site wherein the at least two users store and retrieve data; and
at least one electronic shopping forum on the electronic site wherein at least one user requests at least one of services and goods from at least one provider of at least one of services and goods.

32. The system according to claim 29, further comprising an electronic services forum, wherein at least one of the at least two users makes a request for at least one proposal from the at least one provider.

33. The system according to claim 32, wherein the electronic services forum allows the at least two users to share in the request for the at least one proposal.

34. The system according to claim 31, further comprising a registration module, wherein at least one of the at least two users registers with the registration module by providing user information in a user-profile regarding the at least one user.

35. The system according to claim 34, wherein at least one of the at least two users who registers by providing user information in the user-profile is considered a registered user; and
wherein at least one of the at least two users who does not register by not providing user information in the user profile is considered a non-registered user.

36. The system according to claim 35, wherein at least one registered user is provided access to a plurality of user-forums for registered users and a plurality of user-forums for non-registered users.

37. The system according to claim 36, wherein more user-forums are provided for registered users than for non-registered users.

38. The system according to claim 35, wherein at least one non-registered user is provided access to a plurality of user-forums for non-registered users, and wherein the at least one non-registered user is not provided access to a plurality of user-forums for registered users.

39. The system according to claim 35, wherein content information is entered by at least one registered user into a database.

40. The system according to claim 39, wherein a first registered user limits access of a second registered user to the content information based on the second registered user's user-profile.

41. The system according to claim 39, wherein a registered user defines a group of registered users that are entitled to access the content information submitted by the registered user.

42. The system according to claim 41, wherein the registered user is an employee of a first company, and the group of registered users comprises employees of a second company.

43. The system according to claim 41, wherein the registered user and the group of registered users are employees of a first company.

44. The system according to claim 35, wherein access to at least one database containing content information is available to at least one non-registered user.

45. The system according to claim 35, wherein at least two registered users share costs associated with at least one of services and goods provided by at least one provider of at least one of services and goods; and
wherein the at least two registered users share benefits resulting from the at least one of services and goods received from the at least one provider of at least one of services and goods.

46. The system according to claim 35, further comprising at least one electronic forum added by at least one registered user.

47. The system according to claim 35, wherein at least one registered user requests a symposium using the electronic site.

48. The system according to claim 35, wherein at least one registered user communicates using electronic newsgroups provided on the electronic site.

49. The system according to claim 35, wherein content information is retrieved by using a search engine to access a database in accordance with at least one search criterion.

50. The system according to claim 31, wherein at least one of the at least two users completes at least one survey of the at least one user's experiences with the electronic site.

51. The system according to claim 31, wherein the at least one provider maintain an independent electronic communication site; and
further comprising access to the independent electronic communication site on the electronic site.

52. The system according to claim 31, wherein a fee is charged to at least one provider.

53. The system according to claim 52, wherein the fee is calculated as a function of an amount of business transacted on the electronic site.

54. The system according to claim 52, wherein the fee is calculated as a function of a number of users purchasing at least one of services and goods from the at least one provider.

55. The system according to claim 31, wherein a fee is charged to a user for participation in the electronic site.

56. The system according to claim 55, wherein the fee is calculated as a function of an amount of business transacted by the user.

57. The system according to claim 31, wherein a fee is charged to a group of users for participation in the electronic site.

58. The system according to claim 57, wherein the fee is calculated as a function of a number of users in the group.

59. The system according to claim 31, wherein at least one provider solicits business on the electronic site with advertisements.

60. The system according to claim 31, further comprising a chat facility on the electronic site.
